(19) United States
(12) Patent Application Publication
(10) Pub. No.: US 2025/0108431 A1
(43) Pub. Date: Apr. 3, 2025

(54) Device for manually introducing holes and/or rivets into a workpiece

(71) Applicant: William Prym GmbH & Co. KG, Stolberg (DE)

(72) Inventor: Andreas Papenfuss, Weimar (DE)

(21) Appl. No.: 18/848,523

(22) PCT Filed: Apr. 25, 2023
(86) PCT No.: PCT/EP2023/060728

§ 371 Date: Sep. 21, 2024

(30) Foreign Application Priority Data
Apr. 27, 2022 (DE) 20 2022 102 273.9

(51) Int. Cl. B21J 15/10

(52) U.S. Cl. CPC B21J 15/105

(57) ABSTRACT

The invention relates to a device (10) for manually introducing holes and/or rivets into a workpiece, said device having a body (20) which has a working region (12) into which a workpiece which is to be provided with holes and/or rivets can be introduced. In the working region (12), a tool plate (21) is provided, into which a tool (60) can be introduced, and a tool receptacle (31) is also provided, which is arranged on a slide (30) and into which a counter tool (61) can be introduced. The slide (30) is movable towards the tool plate (21) and away therefrom, the workpiece for machining being arrangeable on the working region (12) between the tool plate (21) and the tool receptacle (31). The invention comprises a handle (40) which is pivotable about a first pivot axis (41) in order to move the slide (30). The slide (30) is arranged away from the tool plate (21) in a release position (30.1) when the handle (40) is in its first position (40.1), and, as the handle (40) is pivoted into its second position (40.2), is moved towards the tool plate (21) into its working position (30.2), in which the tool (60) and the counter tool (61) are operatively connected to one another. Lastly, a stop (11) is provided on the body (20), which, in the second position (40.2) of the handle (40), cooperates with a counter stop (42) on the handle (40) in order to delimit the second second position (40.2) of the handle (40) and thus the movement of the slide (30) towards the tool plate (21) into its working position (30.2). The invention now proposes that the stop (11) and thus the working position (30.2) of the slide (30) are adjustable.

The invention relates to a device for manually introducing holes and/or rivets into a workpiece.

Workpieces which can be used here are, in particular, flat workpieces such as textiles of any kind, leather, plastic films, papers and boards and similar materials, and even workpieces of greater thickness, such as foams, or very bulky materials. With this device, the range of possible materials for the workpieces is nearly unlimited.

### BACKGROUND

In particular in the fields of handicrafts, the production of clothing and accessories, and re-use and recycling of old materials, there is the desire to introduce holes and/or a wide variety of types of rivets into a workpiece, whether for fastening purposes, such as, for example, in classical belt holes and snap fasteners, or for decorative purposes such as in decorative rivets. There can be a variety of shapes for the holes and for the rivets. By “rivet” is meant here any object which is fastened to the object by a rivet or flanging connection, irrespective of whether it is functional or decorative, and irrespective of whether it is arranged on one layer or more than one layer of the workpiece.

Hole and rivet pliers are well known, by means of which corresponding holes and rivets can be introduced into garments, textiles, leather and other materials. These usually include a plurality of male dies and female dies in various sizes. The workpiece is introduced between the male die and the female die, and the workpiece is worked upon by manually pressing together the two jaws of the pliers. Such manual hole or rivet pliers are described, for example, in documents DE 295 16 991 U1 or DE 44 22 103 C2. To make the pliers work, it is required that the user apply a relatively large amount of force, which force must be applied by closing the hand. Many users find it difficult to squeeze the pliers sufficiently.

DE 20 201 3 100 917 U1 describes a folding machine which is designed as a table device to be operated manually. This folding machine serves for cutting off or punching holes in papers, and has possibilities for adjusting the distances to the papers to be perforated in order to punch the holes at a desired location. It is disadvantageous here that, depending on the paper to be processed, a high force must still be applied by a user in order to carry out the machining. Furthermore, the machine does not provide a riveting function.

DE 10 201 1 015 473 A1 likewise describes a manual paper punch which is designed as a table device. Since the forces to be applied vary greatly during the punching of the paper, and in particular thicker stacks might present themselves with conventional books, the handle is designed as a toggle lever which offers a better force transmission, so that even thicker paper stacks can be easily hole-punched manually by a user. In this device too, a riveting or a similar process is not provided. With this punch, it is not possible to adjust the distance between the punches and the holes. When the handle is actuated, the punch dies are always guided into the holes.

The object of the invention is therefore to improve a device for introducing holes and/or rivets into a workpiece in such a way that the actuation for a user is possible with as little effort as possible. It should also be possible to adapt the distance between the tools in order to process rivets of the a wide variety of size or height. This object is achieved by the characterizing features of claim 1, as will now be discussed.

### SUMMARY OF THE INVENTION

The device has a body which has a working region with a tool plate, and a pivotable handle. Furthermore, a movable slide with a tool holder is provided. A tool can be arranged on the tool plate while a counter tool can be introduced into the tool holder. A workpiece to be worked upon can be introduced into the working region, for example made of textile or leather or some other material. By actuating the handle, the slide can be moved toward the tool plate, whereby the tool and the counter tool are engaged with each other and the workpiece is worked upon. In this way, depending on the choice of the tool and counter tool, holes or rivets or similar objects can be produced, which are formed by rivets, crimping or flanging being introduced into the workpiece.

Since both the workpieces and the tool and the counter tool can have different dimensions, a stop is provided on the body which can interact with a counter-stop on the handle, in order to limit the movement of the handle and thus of the slide. According to the invention, the stop is designed to be adjustable in order to limit the working position of the slide differently for different applications. Thus, for each specific application, the working position of the slide can be precisely adjusted.

In a particularly preferred embodiment, the stop is continuously adjustable manually. The exact setting of the working position of the slide for a user is then particularly simple and may be accomplished without the need of additional tools.

The stepless adjustability of the stop can be realized in a particularly simple manner when it is provided by a stop screw. This stop screw can then in turn be located in a bushing, such as a threaded bushing. As a result, a simple and stepless adjustability of the stop is possible independently of the choice of the material of the body. During manufacture, the threaded bushing can be inserted into the body or can be attached to it in a conventional manner. The stop screw can have a knurling or the like on its outer side or can be designed as a wing screw in order to permit simple manual adjustability without the need for additional tools.

It is also preferred to provide a first pivot axis on a joint element. The handle is then pivotable about this first pivot axis about the joint element. Furthermore, however, the joint element is designed in the manner of a toggle lever and has a second pivot axis with which the joint element can be pivoted about the body. In this way, a better transmission of force from the pivoting movement of the handle is possible. In order to enable an ordered linear movement of the slide, a third pivot axis can be provided, which connects the slide so as to be pivotable with the handle. As a result, the pivoting movement of the handle can be converted into a linear movement of the slide. Due to the interaction of the three pivot axes, a particularly good force transmission of the force exerted on the handle and the pivoting movement of the handle becomes a linear movement of the slide, as a result of which reliable working-upon of the workpiece is possible, even in the case of larger rivets.

Different tools and/or counter-tools can be arranged in the tool holder on the slide and/or on the workpiece tool plate. As a result, it is possible to process a wide variety of rivets or to process them to introduce differently sized and/or differently shaped holes into a workpiece. Only one device is required for a wide variety of applications.

In order to carry out a reliable working-upon of the workpiece, the device can have a fastening device by means of which it can be fastened on a planar surface such as a table top. As a result, it is possible to fasten the device securely to a work station and specifically to attach one or more holes and/or rivets to a workpiece at a desired position. The device can then not be inadvertently displaced even when the application of force is greater. The fastening device can comprise, for example, an approximately U-shaped clamp, in the mounted state, engages around an edge of the planar surface. The one leg of the clamp can be fixed to the device, in particular to a receptacle on the body, while the other leg of the clamp can be fixed to the underside of the planar surface. Thus, the U-shaped clamp engages around the planar surface and the device can be fixed to the planar surface with interposition of the clamp. The other leg can preferably be fixed to the planar surface by means of a releasable connection, for example by a clamping connection. For this purpose, the other leg of the clamp is engaged by or surrounded by a fastening means which acts against a counter planar surface which is indirectly or directly adjacent to the planar surface and which is supported on the planar surface. In addition, a protective cover can also be provided, which can be arranged between the planar surface and the counter plate and protects the planar surface from damage which could arise due to the clamping of the counter plate. By means of such a fastening device, the device can be fastened to a conventional planar surface, such as a table top, a shelf or the like, without the planar surface being damaged thereby. After use, the device can then also be removed from the planar surface again. As a result, it is possible to fasten the device virtually everywhere and is therefore particularly well suited for use in hobby activity.

In order to introduce the holes or rivets into the workpiece in a targeted manner, one or more measuring scales can be provided on the device. As a result, it is possible to measure precise distances from the edge of the workpiece to the hole or to the rivet. For example, the position of the tool in relation to the workpiece edge can be read on the measuring scale or measuring scales. One or more of the measuring scales can also be arranged on the device in a displaceable and/or detachable manner. It is also possible to provide one or more projections on a measurement scale, on which an edge of the workpiece can be brought into contact, around the hole or rivet, making it easier to locate the workpiece at a precisely measured location. There can be a variety of numbers and arrangements of the measuring scales.

For better haptics, the handle can consist of two components, namely a hard first component, which imparts the necessary strength and rigidity to the handle and can also withstand greater forces and a softer second component, which is gentle to the hand of the user and has pleasant haptic properties. Thus, the handle ensures good force transmission and is nevertheless comfortable for a user.

The device can have one or more feet which ensure a safe positioning of the device on a surface. This is particularly well given in the case of a number of three feet. In this case, the feet can have anti-slip properties in order to ensure a secure positioning of the device even when force is exerted on the handle.

The slide can be guided in a sleeve in the body. As a result, good guidance of the slide in the body is also provided independently of the material of the body.

Further advantages and embodiments may be seen in the following description, the dependent claims and the drawings. In the drawings, the subject matter of the invention is illustrated in an exemplary embodiment.

### BRIEF DESCRIPTION OF THE DRAWINGS

FIG. 1 shows a side view of a device according to the invention,

FIG. 2: shows the device from FIG. 1 in perspective from the front with the handle in cutaway view,

FIG. 3 is an exploded view of the device of FIGS. 1 and 2,

FIG. 4 shows the device from FIGS. 1 to 3 in a partial manner,

FIG. 5: shows the device with its handle in a first position,

FIG. 6: shows the device with its handle in a pivoting movement,

FIG. 7: shows the device with its handle in a second position,

FIG. 8: shows the device from FIGS. 1 to 7 with the stop in a minimum position,

FIG. 9: shows the device of FIG. 8 with the stop in a maximum position, and

FIG. 10: shows the tool holder and the tool plate in detail.

### DETAILED DESCRIPTION

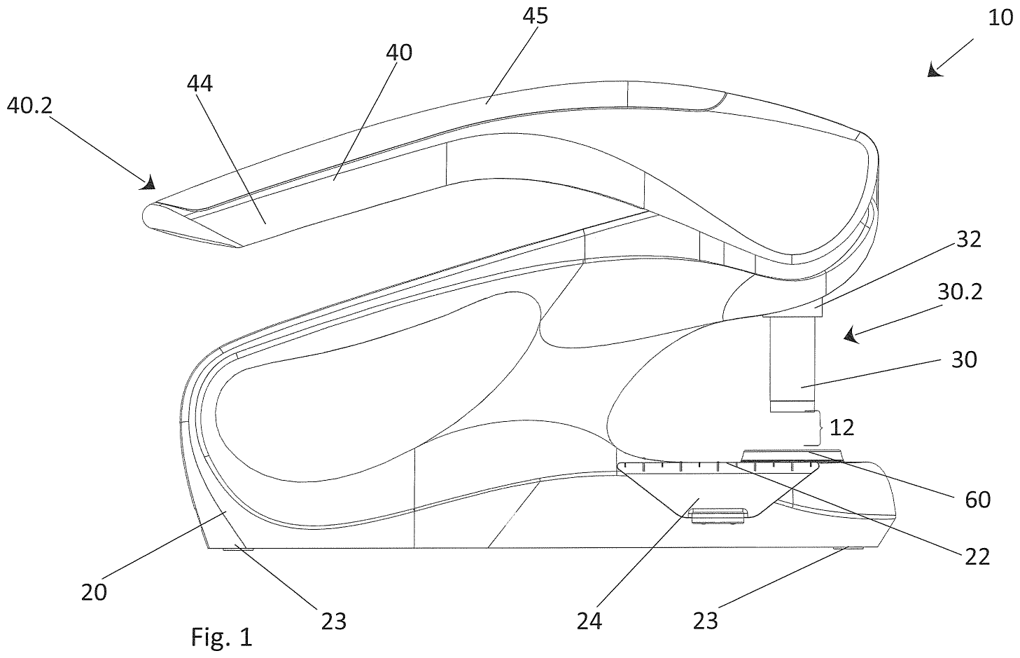

FIG. 1 shows a device 10 according to the invention having a body 20 and a handle 40. Furthermore, a slide 30 can be seen, which is arranged above the tool plate 21 or the lower tool 60. Here, the slide 30 is in its working position 30.2 while the handle 40 is in its second position 40.2. The working region 12 can be seen between the slide 30 and the lower tool 60. The slide 30 is guided in a sleeve 32 through the body 20 and can move linearly toward and away from the lower tool 60. In order to effect a movement of the slide 30, the handle 40 is moved upwards or downwards.

In this exemplary embodiment, the handle 40 itself consists of two different materials, namely a first component 44, which is rigid and rigid and imparts the necessary strength to the handle 40 and a second component 45, which is softer and has a feel which is pleasant for a user. This makes it possible to provide a handle 40, which is at the same time comfortable to actuate and nevertheless is rigid and strong enough to reliably transmit the exerted forces.

Furthermore, a part of a measuring scale 22 can be seen on which, when the device 10 is used, the position of the workpiece can be read or the workpiece can be correctly positioned. A projection 24, which can be used to bear the workpiece, is also provided on the measuring scale 22 shown. It is also possible to provide further measuring scales 22 in order to position the workpiece even more precisely.

Finally, it can be seen that feet 23 are introduced at the bottom into the body 20. These ensure a safe state of the body 20 and can have anti-slip properties, so that even in the event of an exertion of force on handle 40, the device remains well positioned, and good and reliable working-upon of the workpiece can take place.

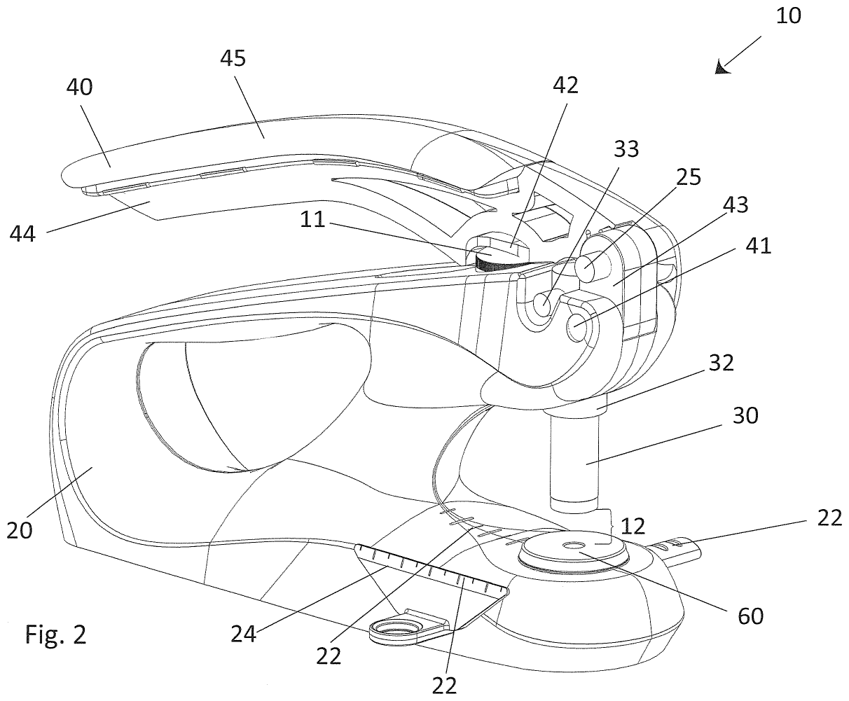

In the illustration in FIG. 2, the structure of the handle 40 and the interaction with the body 20 and the slide 30 are shown in more detail. It can be seen that a joint element 43 is provided, which is designed in the manner of a toggle lever. In this embodiment, a total of three pivot axes are provided. In this exemplary embodiment: a first pivot axis 41 is provided between the handle 40 and the joint element 43, a second pivot axis 25 is provided between the joint element 43 and the body 20, and a third pivot axis 33 is provided between the slide 30 and the handle 40. Due to the interaction of these three pivot axes 41, 25, 33, on the one hand, the pivoting movement of the handle 40 is transmitted to the linear movement of the slide 30, but also, on the other hand, that the force applied during the pivoting of the handle 40 is well translated and transmitted to the slide, so that with a relatively low manually applied force, even greater forces are exerted on the lower tool 60 and the upper tool 61. As a result, even more difficult or difficult hole or riveting operations can be carried out. As a result of the design and arrangement of the axes, a large number of rivet and hole processes which cannot be made with conventional devices can be carried out.

Furthermore, the stop 11, which is arranged on the body 20 and, in the illustrated second position 40.2 of the handle 40, interacts with the counter-stop 42 on the handle 40 and thus not only the exact position of the second position 40.2 of the handle 40, but also the working position 30.2 of the slide 30.

Finally, it can be seen that three measuring scales 22, which can serve for the precise determination of the position of a workpiece, are arranged indirectly or directly on the body. In part, the measuring scales 22 are arranged displaceably and detachably on the body 20 in order to also fix the projection 24 in an exact position and to facilitate the alignment of the workpiece. By means of the multiplicity of measuring scales 22, the alignment and positioning of a workpiece to be worked upon is facilitated.

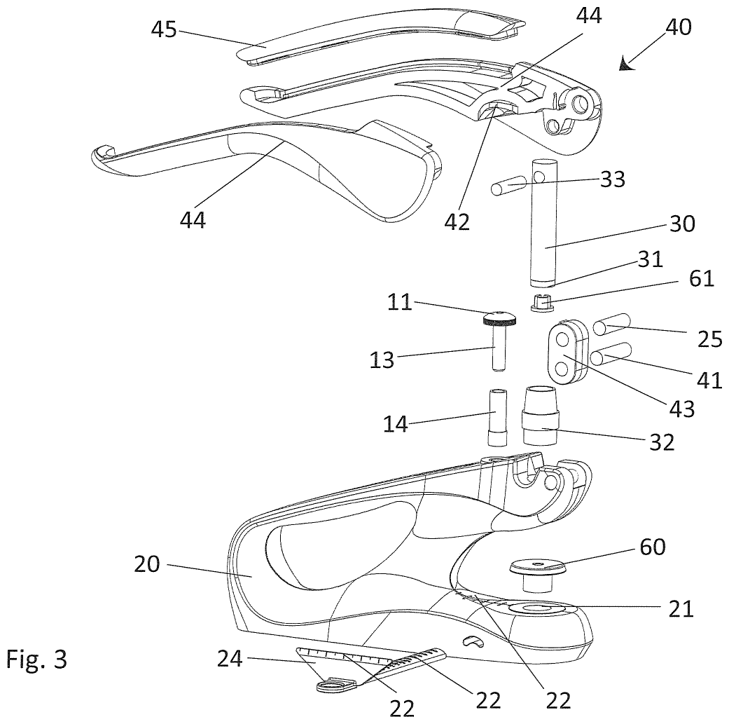

The exact construction of the device 10 can be seen in the exploded view in FIG. 3. Here, the structure of the handle 40 is shown, which consists of two components--the first component 44 and the second component 45. The structure of the slide 30, which is arranged in the sleeve 32 in the body 20, and the structure of the upper tool 61, can also be seen here. The joint element 43 with the first pivot axis 41 and the second pivot axis 25 as well as the third pivot axis 33, which acts on the slide 30 and connects the latter to the handle 40, can also be seen.

The stop 11 is provided on a stop screw 13. This in turn is guided in a bushing 14, which is designed as a threaded bushing with an internal thread. This bushing 14 can also be introduced into the body 20 independently of the material of the body 20 itself. As a result of the design as a stop screw 13 and bushing 14, a stepless manual adjustment of the stop 11 is possible in a simple manner. The stop screw 13 has knurling in order to simplify manual adjustment.

It can also be seen that the lower tool 60 is inserted into or applied to the tool plate 21. The lower tool 60 can be exchanged by a user in order to satisfy a particular application.

One of the three measuring scales 22 shown is completely removable from the body 20. A projection 24, which in turn comprises a further measuring scale 22, is provided on this measuring scale 22. The displaceable measuring scale can be detachably fastened to the body 20 in order to adjust the distance of the projection 24 from the slide 30. A third measuring scale 22 is fixedly attached to the body 20. By means of the plurality of measuring scales 22, a workpiece to be worked upon can be precisely aligned towards the lower tool 60 and upper tool 61.

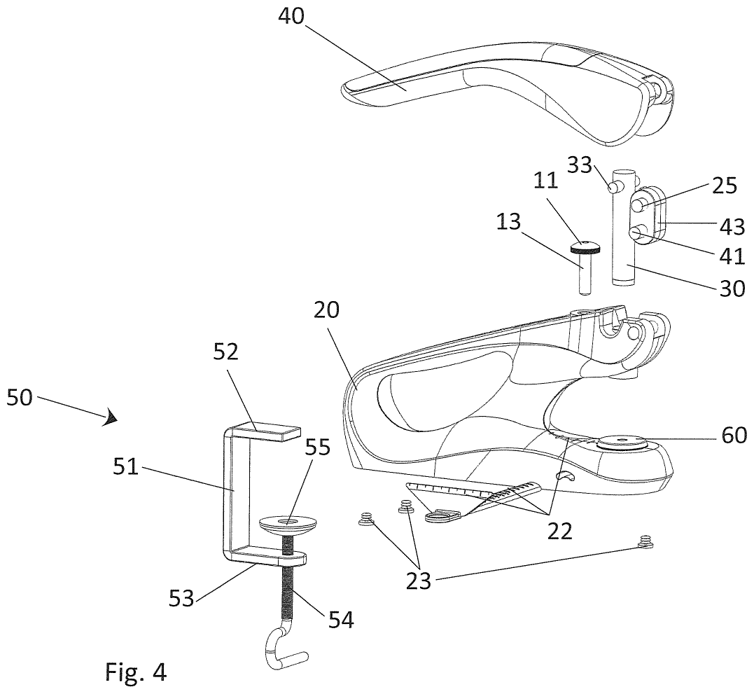

The construction of a possible fastening device 50 can be seen more precisely from FIG. 4. In this case, an approximately U-shaped clamp 51 is provided which, in the fastening case, for example, makes use of an edge of a planar surface such as a table top, a shelf bottom or the like. In this case, a first leg 52 of the U-shaped clamp 51 can be mated to the device 10 itself, for example to the body 20, while a second leg 53 engages under the planar surface and can be clamped against the underside of the planar surface. Furthermore, a fastening means 54 is provided for fastening, in this case a screw which passes through the second leg 53 of the U-shaped clamp 51. This fastening means 54 serves as a screw head for a handle, which can be actuated manually in a simple manner. A counter plate 55 is also provided on the side of the fastening means 54 facing away from the handle, which grips the underside of the planar surface and thus secures the device 10 on the planar surface against displacement. Not shown here is a protective cover which can be arranged between the counter plate 55 and the planar surface, in order to protect the planar surface from damage such as scratches or impressions by the counter plate 55.

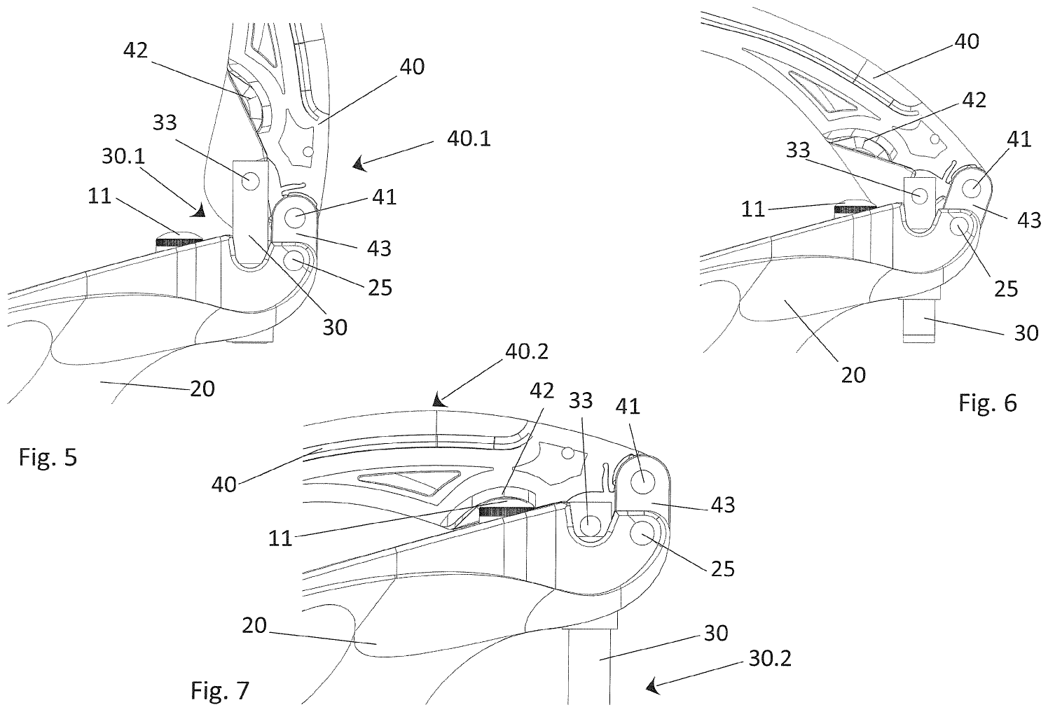

FIGS. 5 to 7 show the movement of the handle 40, of the slide 30 and of the joint element 43. In FIG. 5, the handle 40 is in its first position 40.1 and the slide 30 is in its release position 30.1. The joint element 43 is arranged almost perpendicularly and the first pivot axis 41 and the second pivot axis 25 are approximately perpendicular to one another. The third pivot axis 33 is arranged at a distance from the other two. If the handle 40 is now actuated to punch a hole or to place a rivet, the three pivot axes 41, 25 and 33 move as shown in FIG. 6. As a result of the arrangement of the pivot axes and the guidance of the slide 30 through the sleeve 32, the pivoting movement of the handle 40 into one linear movement of the slide 30 is implemented. Due to the configuration of the joint element 43 as a toggle lever, a favorable force transmission of the pivoting movement of the handle 40 takes place so that less force has to be applied by a user compared with what would be needed with pliers. Finally, FIG. 7 shows the handle 40 in its second position 40.2 and the slide 30 in its working position 30.2. The upper tool 61 located in the slide 30 has been moved maximally in the direction of the lower tool 60 and a workpiece arranged in the working region 12 has been worked upon by the lower tool 60 and the upper tool 61. As a result of the interaction of the stop 12 and the counter-stop 42, the handle 40 cannot be pivoted further downwards.

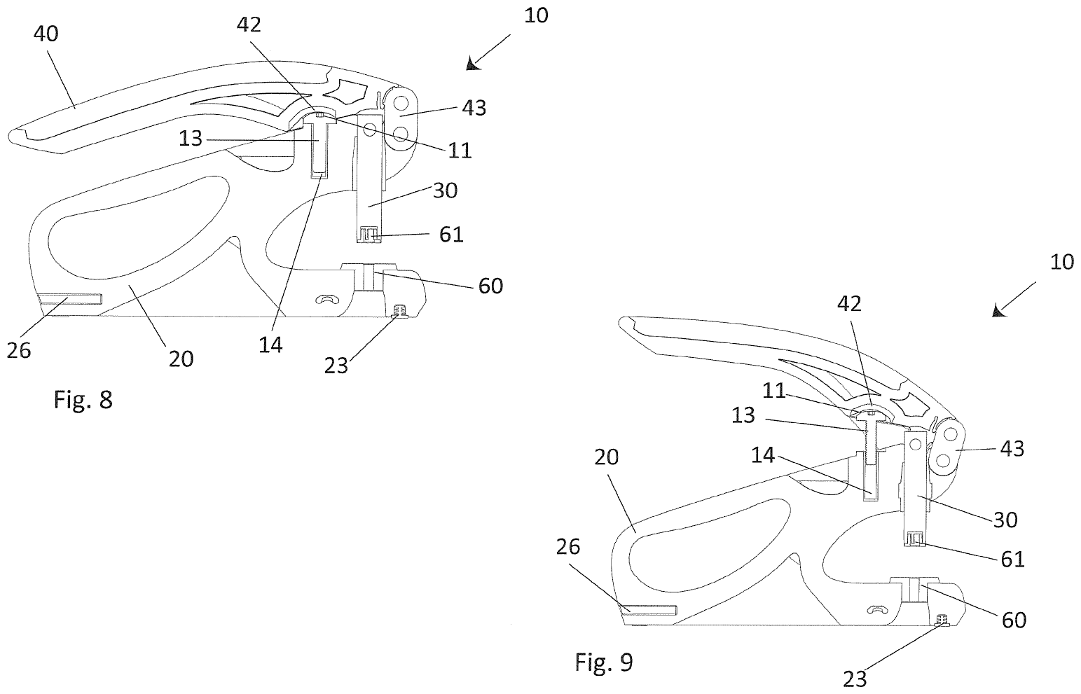

The function of the stop 11 and of the counter-stop 42 is also shown in FIGS. 8 and FIG. 9. In this case, the stop 11 is provided on the stop screw 13, which is located in the bushing 14. The bushing 14 has an internal thread for the external thread of the stop screw 13. In FIG. In FIG. 8, the stop screw 13 is screwed fully into the bushing 14. The second position 40.2 of the handle 40 is pivoted to a maximum extent and the working position 30. FIG. 2 of the slide 30 is likewise such that the upper tool 61 is moved to a maximum extent on the lower tool 60. In FIG. 9, on the other hand, the stop screw 13 is screwed as far out of the bushing 14 as possible. Handle 40 is also in its second position 40.2, but this is pivoted much less far than in FIG. 8, since counter-stop 42 rests much earlier on stop 11. In this position, the slide 30 is also in its working position 30.2, but the upper tool 61 is at most remote from the lower tool 60. Between the two extremes shown in the Figures FIGS. 8 and 9, one can appreciate intermediate results, depending on how far the stop screw 13 is screwed into the bushing 14.

In addition, FIGS. 8 and 9 show the receptacle 26 into which the first leg 52 of the U-shaped clamp 51 can be introduced in order to mate the fastening device 50 to the device 10. If no fastening device 50 is provided, the receptacle 26 remains empty.

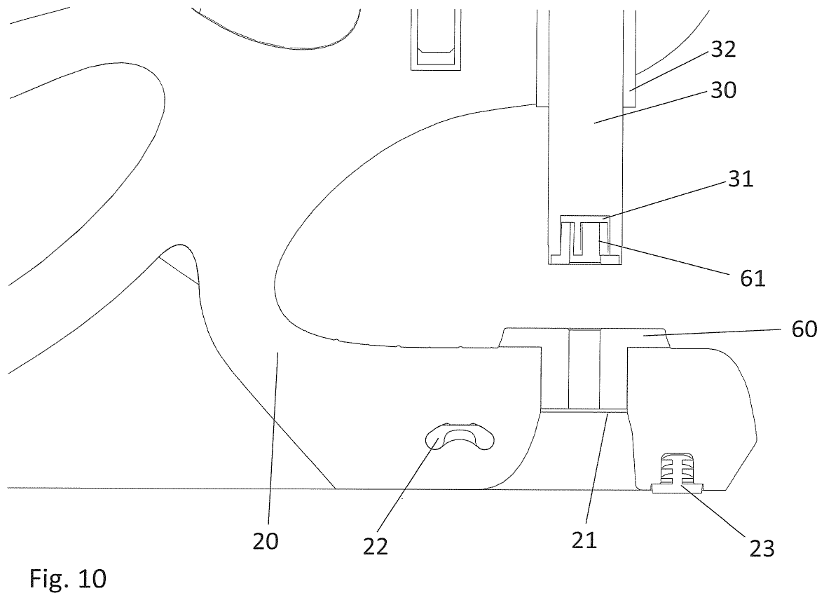

Finally, FIG. 10 shows the tool plate 21 onto which the lower tool 60 has been applied and the upper tool receptacle 31 with the upper tool 61 inserted therein and the upper tool 61 are aligned with respect to one another. If, for example, a rivet is to be processed on a workpiece, then the rivet or the two parts of the rivet is placed on the lower tool 60 and/or upper tool 61 and the workpiece to be worked upon is arranged therebetween. Thereafter, the slide 30 is brought into its working position 30.2 by actuating the handle 40 and the rivet is arranged on the workpiece. For different rivets and holes, different tools and counter tools are used, which can be correspondingly arranged on the device.

Finally, it should be pointed out that the embodiments illustrated here are merely exemplary implementations of the invention. This is not limited thereto. Rather, further modifications and improvements are possible without departing from the invention as claimed.

### LIST OF REFERENCE SYMBOLS

10 device
11 stop
12 working region
13 stop screw
14 bushing
20 body
21 tool plate
22 measurement scale
23 feet
24 projection
25 second pivot axis
26 receptacle
30 slide
30.1 slide release position
30.2 slide working position
31 upper tool receptacle
32 sleeve
33 third pivot axis
40 handle
40.1 handle first position
40.2 handle second position
41 first pivot axis
42 counter stop
43 joint element
44 first handle component
45 second handle component
50 fastening device
51 U-shaped clamp
52 first leg of U-shaped clamp
53 second leg of U-shaped clamp
54 fastening means of U-shaped clamp
55 counter-plate
60 lower tool
61 upper tool

1. A device (10) for manually introducing holes and/or rivets into a workpiece
having a body (20) which has a working region (12) into which a workpiece is introducible which is to be provided with holes and/or rivets, wherein a tool plate (21) is provided on the working region (12), into which a lower tool (60) is placed, and wherein furthermore a tool holder (31) is provided, which is arranged on a slide (30) and into which an upper tool (61) is placed, wherein the slide (30) is movable towards and away from the tool plate (21), and wherein the workpiece can be arranged between the tool plate (21) and the tool holder (31) for working upon the workpiece within the working region (12),
wherein a handle (40) is provided which is pivotable about a first pivot axis (41) in order to move the slide (30),
wherein when the handle (40) is in a first position (40.1), the slide (30) is arranged away from the tool plate (21) in a release position (30.1) and
when the handle (40) is pivoted into a second position (40). 2), the slide (30) is moved towards the tool plate (21) into a working position (30.2), in which the lower tool (60) and the upper tool (61) are operatively connected to one another,
and wherein a stop (11) is provided on the body (20) which, in the second position (40.2) of the handle (40), interacts with a counter-stop (42) on the handle (40), the second position (40. 2) the handle (40) giving rise to movement of the slide (30) towards the tool plate (21) and into its working position (30.2),
the device characterized:
in that the stop (11) and thus the working position (30.2) of the slide (30) are adjustable.

2. The device (10) according to claim 1, characterized in that the stop (11) can be manually adjusted continuously.

3. The device (10) according to claim 2, characterized in that the stop (11) is located on a stop screw (12) which is arranged in a bushing (13).

4. The device (10) according to claim 1, characterized in that the first pivot axis (41) of the handle (40) is arranged on a joint element (43), wherein the joint element (43) is configured as a toggle lever and has a second pivot axis (25) about which the joint element (43) can be pivoted about the body (20).

5. The device (10) according to claim 4, characterized in that the slide (30) is arranged on the handle (40) so as to be raised and lowered in relation to a third pivot axis (33).

6. The device (10) according to claim 1, characterized in that different lower tools (60) and/or upper tools (61) can be inserted into the tool plate (21) and/or into the tool holder (31) on the slide (30).

7. The device (10) according to claim 1, characterized in that a fastening device (50) is provided in order to fix the device (10) to a planar surface such as a table top.

8. The device (10) according to claim 7, characterized in that the fastening device (50) comprises an approximately U-shaped clamp (51), which in its mounted state engages around an edge of the planar surface and whose first leg (52) can be fixed to the device (10), in particular in a receptacle (26) on the body (20), while the second leg (53) can be fixed to the underside of the planar surface.

9. The device (10) according to claim 8, characterized in that the second leg (53) can be fixed to the planar surface by means of a releasable connection, wherein the second leg (53) is has a fastening means (54), which acts against a counter plate (55) which rests against underside of the planar surface.

10. The device (10) according to claim 9, characterized in that a protective cover is provided which is arranged between the counter plate (55) and the planar surface.

11. The device (10) according to claim 1, characterized in that at least one measuring scale (22) is provided, on which the position of the workpiece can be read in relation to the tool (60) and the counter tool (61).

12. The device (10) according to claim 11, characterized in that the at least one measuring scale (22) is arranged in a displaceable and/or detachable manner on the device (10).

13. The device (10) according to claim 1, characterized in that the measuring scale (22) has at least one projection (24) for contacting the workpiece.

14. The device (10) according to claim 1, characterized in that the handle (40) consists of at least two components, namely a first component (44), which is hard and provides good force transmission, and a second component (45) which is softer and has pleasant haptic properties for an operator.

15. The device (10) according to claim 1, characterized in that the body (20) has one or more feet (23) which have anti-slip properties.

16. The device (10) according to claim 1, characterized in that the slide (30) is guided in the body (20) in a sleeve (32).
